(19) United States
(12) Patent Application Publication
(10) Pub. No.: US 2022/0323992 A1
(43) Pub. Date: Oct. 13, 2022

(54) BASE MATERIAL ADJUSTING METHOD

(71) Applicant: MIZUKAMI PAINT CO., LTD., Niihama-shi (JP)

(72) Inventor: Kenji MIZUKAMI, Niihama-shi (JP)

(73) Assignee: MIZUKAMI PAINT CO., LTD., Niihama-shi (JP)

(21) Appl. No.: 17/229,176

(22) Filed: Apr. 13, 2021

(51) Int. Cl. B05D 3/10; B05B 15/55; B05B 14/00; B05D 3/12

(52) U.S. Cl. CPC B05D 3/104; B05B 15/55; B05B 14/00; B05D 3/12

(57) ABSTRACT

A base material adjusting method capable of removing an already-existing coating film with one time construction, which is suitable in terms of prevention of health problems of operators and in terms of environmental protection, and capable of suppressing disposal costs of waste. The base material adjusting method includes a coating film removing step of removing an already-existing coating film of a work object of the repainting operation by a wet blast method, and a rust removing step of removing rust generated after the coating film removing step by a dry blast method, and rust inhibitor is not included in slurry used in the wet blast method in the coating film removing step.

### TECHNICAL FIELD

The present invention relates to a base material adjusting method in a repainting operation.

### BACKGROUND TECHNIQUE

Conventionally, as a base material adjustment for carrying out a repainting operation on a construction such as a bridge, there are used a release material method, a dry blast method, a wet blast method and the like.

The release material method is a method in which a release agent is applied to an already-existing coating film, the already-existing coating film is impregnated with the release agent, thereby softening the already-existing coating film, and the softened already-existing coating film is scraped by a scraper to adjust a base material. This method has a merit that generation of dust is small and the amount of waste is also small. However, it is necessary to carry out the operations more than once in some cases to completely remove the already-existing coating film depending upon kinds of paint and thickness of the already-existing coating film, and reaction time of the release agent is largely varied by outside air temperature, and there are problems that costs are increased and construction period is extended.

The dry blast method is a method in which abrasive material is sprayed on an already-existing coating film by compressed air to remove the already-existing coating film, and base material is adjusted. This method has a merit that it is possible to remove the already-existing coating film with one construction without depending upon a state of the already-existing coating film or the outside air temperature. According to this method, however, abrasive material and removed already-existing coating film scatter as dust. Therefore, when the already-existing coating film includes harmful material such as PCB and hexavalent chromium, there is a problem in terms of prevention of health problems of operators. Actually, in Notification “Concerning prevention of health problems of labors of peeling-off operation and scraping operation of paint including harmful material such as lead” made by Ministry of Health, Labor and Welfare in 2014, it is described to certainly damp without fail in the peeling-off operation and the scraping operation of an already-existing coating film.

According to a wet blast method as described in patent document 1, on the other hand, slurry made by mixing abrasive material and liquid is sprayed onto an already-existing coating film by compressed air, thereby removing the already-existing coating film to adjust base material unlike the dry blast method. That is, the operation is carried out while damping. Therefore, it is possible to suppress the generation of dust, and this is suitable in term of prevention of health problems of operators.

### PRIOR ART DOCUMENT

### Patent Document

[Patent Document 1] Japanese Patent Application Laid-open No. 2012-121121

### SUMMARY OF THE INVENTION

### Problem to be Solved by the Invention

However, according to the wet blast method, in order to suppress the generation of return rust, rust inhibitor is usually added to slurry (see paragraph [0015] of patent document 1), but since the rust inhibitor itself includes harmful material, when the operation is carried out in the vicinity of a river such as a bridge, it is feared that the harmful material flows into the river.

The blast method is extremely excellent because it is possible to remove the already-existing coating film with one construction without depending upon a state of the already-existing coating film or the outside air temperature as compared with the release material method. However, since abrasive material after usage also becomes waste, there is a problem that the waste is increased as compared with the release material method. According to this, if waste includes specified controlled industrial waste having harmful material of more than a criterion value, since there is a risk that costs concerning disposal of the waste becomes extremely expensive, if the already-existing coating film includes harmful material, the current state is that the operation is carried out by the release material method instead of the blast method.

The present invention has been accomplished in view of the conventional problems. An object of the invention is to provide a base material adjusting method capable of removing an already-existing coating film with one time construction, which is suitable in terms of prevention of health problems of operators and in terms of environmental protection, and capable of suppressing disposal costs of waste.

### Means for Solving the Problem

A base material adjusting method according to a first aspect of the present invention includes a coating film removing step of removing an already-existing coating film of a work object of the repainting operation by a wet blast method, and a rust removing step of removing rust generated after the coating film removing step by a dry blast method.

According to a base material adjusting method of a second aspect of the invention, rust inhibitor is not included in slurry used in the wet blast method in the coating film removing step.

A base material adjusting method of a third aspect of the invention includes a first recovering step of recovering first waste generated in the coating film removing step, and a second recovering step of recovering second waste generated in the rust removing step, and an amount of abrasive material used in the wet blast method is adjusted such that the first waste becomes general waste based on harmful material included in an already-existing coating film of the work object in the coating film removing step.

A base material adjusting method according to a fourth aspect of the invention includes a third recovering step of recovering third waste which is composed of first waste generated in the coating film removing step and second waste generated in the rust removing step, and amounts of the abrasive materials used in the wet blast method and the dry blast method are adjusted such that the third waste becomes general waste based on harmful material included in an already-existing coating film of the work object in the coating film removing step and the rust removing step.

A base material adjusting method of a fifth aspect of the invention includes a waste recovering step of recovering first waste generated in the coating film removing step and second waste generated in the rust removing step, based on harmful material included in the already-existing coating film of the work object, it is selected and executed whether an amount of abrasive material used in the wet blast method is adjusted such that the first waste becomes general waste in the coating film removing step, and the first waste and the second waste are separately recovered in the waste recovering step, or amounts of abrasive materials used in the wet blast method and the dry blast method are adjusted such that third waste which is composed of the first waste and the second waste becomes general waste in the coating film removing step and the rust removing step, and the third waste is recovered in the waste recovering step.

According to the above configuration, it is possible to previously search kinds or an amount of harmful material included in an already-existing coating film of the work object, and to adjust amounts of abrasive materials used in the wet blast method and the dry blast method in accordance with a result of the search such that the waste becomes general waste. Therefore, it is possible to suppress disposal costs of waste.

### Effect of the Invention

According to the present invention, after an already-existing coating film is removed by the wet blast method, return rust can be removed by the dry blast method. Therefore, it is possible to reliably remove the already-existing coating film with one construction. Further, when the already-existing coating film is removed, a work object is moistened with water. Therefore, the invention is suitable in terms of prevention of health problems of operators. Further, since return rust is removed by the dry blast method, it is unnecessary to carry out rust countermeasures in the wet blast method, and since it is unnecessary to use rust inhibitor, there is no fear that harmful material generated by rust inhibitor flows into a river. Furthermore, it is possible to respectively recover or separately recover waste generated when the already-existing coating film is removed and waste generated when rust is removed. Therefore, it is possible to select a method which can most suppress the disposal costs of waste.

### BRIEF DESCRIPTION OF THE DRAWINGS

FIG. 1 is a flowchart for explaining a base material adjusting method according to an embodiment;

FIG. 2 is a schematic diagram for explaining a selecting method of steps;

FIG. 3 is a flowchart for explaining a pattern A;

FIG. 4 is a diagram showing a configuration of a suspended scaffold; and

FIG. 5 is a flowchart for explaining a pattern B.

### MODE FOR CARRYING OUT THE INVENTION

An embodiment of the present invention will be described below based on the drawings. The embodiment shown below is an example for embodying a technical idea of the present invention, and the invention is not limited to the embodiment. This specification does not limit members described in patent claims to members described in the embodiment. Sizes, materials, shapes, relative placements and the like of constituent parts described in the embodiment do not limit the scope of the invention to them unless noted otherwise, and the constituent parts are merely for example of explanation. Sizes, positional relations and the like of the members shown in the drawings are exaggerated in some cases to clarify the explanation. In the following explanation, the same names and symbols show the same or homogeneous members, and detailed explanation is appropriately omitted. Elements which constitute the present invention may be constituted by a plurality of the members, and one member may commonly use a plurality of elements, or a plurality of members may share and realize a function of one member.

### (Base Material Adjusting Method)

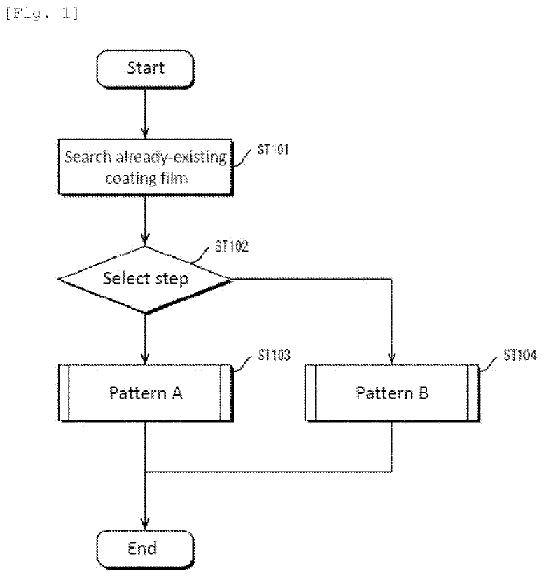

A base material adjusting method according to the embodiment will be described below based on FIGS. 1 to 5.

According to the base material adjusting method of the embodiment, as shown in a flowchart in FIG. 1, an already-existing coating film is searched in step ST101, and a pattern A (step ST103) or a pattern B (step ST104) is selected, in step ST102, as a subsequent step in accordance with a result of the search made in step ST101. When the pattern A is selected, waste generated when the already-existing coating film is removed (this waste is called “first waste”, hereinafter), and waste generated when rust is removed (this waste is called “second waste”, hereinafter) are respectively recovered when the respective operations are terminated. When the pattern B is selected on the other hand, the first waste and the second waste are recovered as one waste (this waste is called “third waste”, hereinafter).

When the waste is discarded, disposal cost largely differs whether this waste is general waste or specified management waste. More specifically, disposal cost of general waste is currently 25 yen per kilogram, but disposal cost of specified management waste including lead of a criterion value or more is 100 yen per kilogram, and disposal cost of specified management waste including PCB of a criterion value or more is 2,600 yen per kilogram. According to the base material adjusting method of the embodiment, it is possible to suppress disposal cost of waste by appropriately making the above-described selection. Details of each of the steps will be described below.

In the case of construction of a large building such as a bridge, its space is divided into constant scopes, and the scopes are constructed in sequence in some cases. In this case, the base material adjusting method of the embodiment can be applied to each of the divided scopes.

### (Search of Already-Existing Coating Film: Step ST101)

In step ST101, the already-existing coating film is searched. Specifically, a sample is collected from an already-existing coating film, component of the already-existing coating film, especially, kinds and an amount of harmful material are searched. It is not always necessary that an operator carries out this search (currently, when an order of construction of repainting operation is placed, this ordering party has an obligation to declare component of the already-existing coating film to the operator). When a sample is collected, an amount (or other equivalent element) of an already-existing coating film per unit area is measured. By the above-described search, it is possible to make a more suitable selection in the following step.

### (Selection of Step: Step ST102)

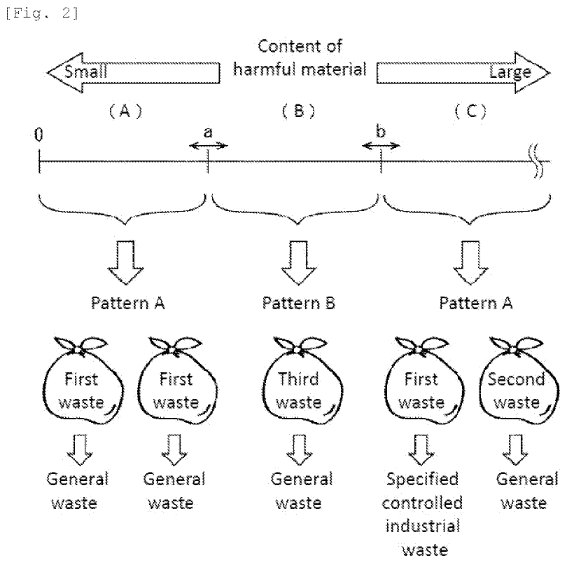

In step ST102, the pattern A or the pattern B is selected as the subsequent step. When selecting the pattern, content rates of harmful materials of the first waste and the third waste generated by the construction per unit are first calculated based on a result of the search in step ST101, and as shown in the schematic diagram of FIG. 2, it is specified whether the already-existing coating film corresponds to a case (A) where the first waste includes harmful material of an amount which becomes general waste, a case (B) where the third waste includes harmful material of an amount which becomes general waste, and a case (C) where the third waste includes harmful material of an amount which becomes specified controlled industrial waste. For example, when the harmful material included in the already-existing coating film is lead, it is determined that the waste is general waste if an elution amount is less than 0.3 mg/L, and it is determined that the waste is specified controlled industrial waste if the elution amount is equal to or more than 0.3 mg/L. Therefore, based on this, it is specified that the case corresponds to any of the cases (A) to (C).

As a result of this, if the case corresponds to the cases (A) and (C), the pattern A is selected, and if the case corresponds to the case (B), the pattern B is selected. According to the above-described selecting method, it is possible to select one of the patterns A and B which can more suppress the disposal cost of waste. More specifically, the case (A) is the case where content of harmful material of the already-existing coating film is relatively small. It is possible to dispose the first waste and the second waste as general waste by selecting the pattern A. In order to respectively recover the first waste and the second waste, if construction is carried out on a scaffolding such as adjustment of base material of a bridge, since operation environment has a limit on a load, it is preferable that the pattern A is selected. Conversely, and the operation environment does not have a limit on the load, the pattern B may be selected.

The case (B) is a case where the content of the harmful material of the already-existing coating film is relatively large, and in the state of the first waste, waste becomes the specified management waste. By selecting the pattern B, it is possible to lower the content rate of harmful material by mixing second waste which does not include harmful material with the first waste, and the third waste can be disposed as general waste.

The case (C) is a case where the content of the harmful material of the already-existing coating film is larger, and even if the second waste is mixed with the first waste and the content rate of the harmful material is reduced, the third waste does not become the general waste. By selecting the pattern A, the first waste can be disposed as the specified management waste, and the second waste can be disposed as the general waste, and the specified management waste can be minimized.

An amount of slurry used in the wet blast method and an amount of abrasive material used in the dry blast method can be adjusted, and constant amplitudes exist in boundaries between the cases (A) and (B) and between the cases (B) and (C) (a and b in FIG. 2). The amplitude a of the boundary between the cases (A) and (B) depends on a splaying amount of slurry of the wet blast method. If the splaying amount of slurry is increased, since the content rate of harmful material is reduced, the scope of the case (A) is widened, and if the splaying amount of slurry is reduced, since the content rate of harmful material is increased, the scope of the case (B) is widened. The splaying amount of slurry can appropriately be adjusted within such a range that the already-existing coating film can be removed and base material is not excessively scraped. If the splaying amount of slurry per unit area is adjusted based on the result of search of the amount of the already-existing coating film per unit area in step ST101, the content rate of harmful material can be adjusted. The amplitude b of the boundary between the cases (B) and (C) depends on the splaying amount of slurry of the wet blast method and the splaying amount of abrasive material of the dry blast method. If the splaying amount of the slurry or the abrasive material is increased, since the content rate of the harmful material is reduced, the scope of the case (B) is widened, and if the splaying amount of the slurry or the abrasive material is reduced, since the content rate of the harmful material is increased, the scope of the case (C) is widened. The splaying amount of the abrasive material can appropriately be adjusted within such a range that the return rust can be removed and the base material is not excessively scraped. If the splaying amount of the slurry and the splaying amount of the abrasive material per unit areas are adjusted based on the result of search of the already-existing coating film per unit area of step ST101, the content rate of the harmful material can be adjusted. Therefore, it is preferable to adjust the subsequent step while taking these adjustments into consideration.

When the already-existing coating film does not include the harmful material in the case (A), it is not always necessary to carry out the step of the pattern A, and base material may be adjusted merely by the dry blast method. In the case (C) also, it is not always necessary to carry out the step of the pattern A, and the base material may be adjusted merely by the release material method. The selecting method and selecting criterion are not limited to those described above.

### (Pattern A)

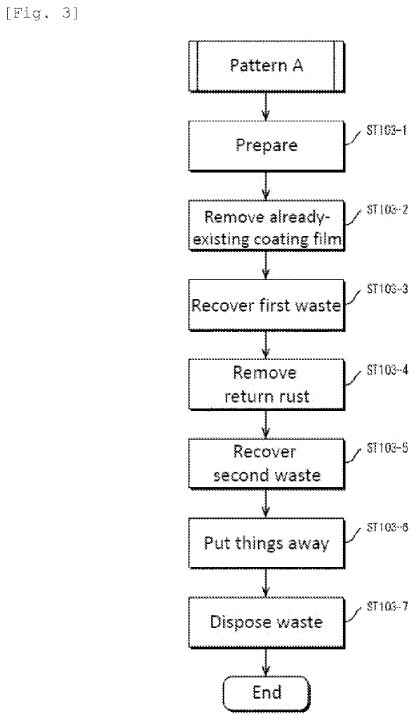

As shown in FIG. 3, in the pattern A, base material is adjusted by steps ST103-1 to steps ST103-7. The steps will be described in detailed below.

### (Preparation: Step ST103-1

In step ST103-1, preparation is carried out for the subsequent steps. More specifically, preparation of a blast device and abrasive material used in the wet blast method and the dry blast method is carried out, and preparation for a vacuum device for recovering waste is carried out.

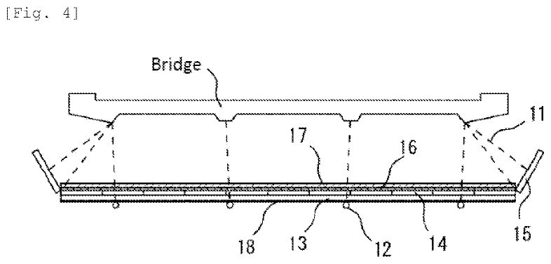

When base material of a bridge is adjusted, for example, if scaffolding is required, the scaffolding is assembled in this step. The scaffolding when base material of a bridge is adjusted is a scaffolding suspended scaffold 1 as shown in FIG. 4 for example. The scaffolding suspended scaffold 1 is composed of scaffolding chains 11, snacks 12, a rolling 13, a scaffolding board 14, morning glories (protective shelves), flameproof sheets 16, plastic cardboards 17 and a safety net 18. The plurality of flameproof sheets 16 are placed on the scaffolding board 14 without space, and the plurality of plastic cardboards 17 are placed on the flameproof sheets 16 without space. The plurality of flameproof sheets 16 are adhered to each other through a curing tape to prevent waste from flowing out from a joint of the scaffolding board 14. The plastic cardboards 17 prevent the flameproof sheets 16 from being sucked by a vacuum device when the waste is recovered.

### (Removal of Already-Existing Coating Film: Step ST103-2)

In step ST103-2, already-existing coating film is removed by the wet blast method. Slurry used in the wet blast method is not especially limited but as the abrasive material, ferronickel slag can be used for example. Liquid which is mixed with the abrasive material is not also especially limited, but it is preferable to use fresh water which does not include rust inhibitor. Because according to the base material adjusting method of the embodiment, since return rust is removed in the dry blast method in the subsequent step, it is unnecessary to carry out the rust countermeasures in this step. According to this, there is no fear that harmful material flows into a river even the operation is carried out in the vicinity of a river such as a bridge, and this is preferable in terms of environmental protection. It is only necessary that liquid is mixed into slurry in such a degree that waste does not fly as dust, and if the amount of liquid is excessively large, a risk that waste flows out from a construction site becomes high and therefore, it is preferable that the amount of liquid is small.

### (Recovery of First Waste: Step ST103-3)

Step ST103-3 is a step where first waste generated in step ST103-2 is recovered, and this step corresponds to one example of a first recovering step in patent claims. Wastes are sucked by negative pressure of the vacuum device, and the wastes are collected in one place.

### (Removal of Return Rust: Step ST103-4)

In step ST103-4, return rust is removed by the dry blast method. The abrasive material used in the dry blast method is not especially limited, but ferronickel slag can be used as in step ST103-2. The dry blast method in this step and the wet blast method in step ST103-2 can commonly use the blast device. If the same abrasive material is used, this is preferable because it is possible to switch between the dry blast method and the wet blast method only by switching between mixing and not-mixing of water.

### (Recovery of Second Waste: Step ST103-5)

Step ST103-5 is a step where second waste generated in step ST103-4 is recovered, and this step corresponds to one example of a second recovering step in the patent claims. Waste may be recovered using the same vacuum device as that of step ST103-3, but it is important that the first waste and the second waste should not be mixed.

### (Putting Things Away: Step ST103-6)

In step ST103-6, the blast device, the abrasive material, the vacuum device, the scaffolding and the like are put away. The order of this step and step ST103-7 may be reversed or these steps may be carried out simultaneously.

### (Disposal of Waste: Step ST103-7)

In step ST103-7, the first waste and the second waste are respectively disposed. According to this, when the already-existing coating film corresponds to the case (C) for example, the first waste can be disposed as specified management waste and the second waste can be disposed as general waste. Therefore, the specified management waste can be minimized, and it is possible to suppress the disposal cost.

### (Pattern B: Step ST104)

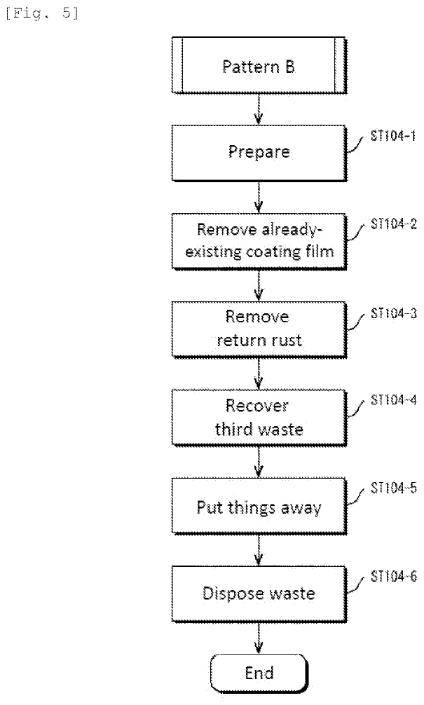

As shown in a flowchart of FIG. 5, in the pattern B, base material is adjusted by steps of step ST104-1 to step ST104-6. Each of the steps will be described below in detail. Step ST104-1 is the same as step ST103-1, step ST104-2 is the same as step ST103-2, step ST104-3 is the same as step ST103-4, and step ST104-5 is the same as step ST103-6. Therefore, explanation thereof will be omitted.

### (Recovery of Third Waste: Step ST104-4)

In step ST104-4, first waste generated in step ST104-2 and second waste generated in step ST104-3 are combined with each other, and they are recovered as third waste. Step ST104-4 corresponds to one example of the third recovering step. The recovering step is not especially limited but if scaffolding is used in the construction, if already-existing coating film is removed by the wet blast method, and if return rust is removed by the dry blast method without recovering the first waste, a state where the first waste and the second waste are accumulated on the scaffolding is established. If this is sucked by the vacuum device, the first waste and the second waste are naturally combined with each other and they can be recovered as the third waste. Alternatively, the first waste and the second waste are respectively recovered, and they may be mixed with each other as the third waste subsequently.

### (Disposal of Waste: Step ST104-6)

Third waste is disposed in step ST104-6. According to this, when the already-existing coating film corresponds to the case (B), it becomes the specified management waste in a first waste state, but if the second waste having no harmful material is mixed with the first waste and they are brought into the third waste, the content rate of the harmful material can be reduced and it is possible to dispose the third waste as general waste.

As described above, according to the present invention, the wet blast method and the dry blast method which are stayed away due to a relation of disposal cost of waste are used together. According to this, the following four effects can be exhibited at the same time.
(1) It is possible to remove an already-existing coating film with one construction.
(2) As wetting progresses, it is possible to suppress the scattering of dust including harmful material. Therefore, it is possible to prevent health disturbance of operators.
(3) Since it is unnecessary to use rust inhibitor having harmful material, this is preferable also in terms of environmental protection.
(4) It is possible to select whether waste is disposed as first waste and second waste or the waste is disposed as third waste. Therefore, it is possible to select a step which can further suppress the disposal cost of waste (it is possible to suppress disposal cost of waste).

### INDUSTRIAL APPLICABILITY

The base material adjusting method of the present invention can suitably be applied to adjustment of base material such as a building structure in which an already-existing coating film includes harmful material.

### EXPLANATION OF SYMBOLS

1 scaffolding suspended scaffold
11 scaffolding chains
12 snack
13 rolling
14 scaffolding board
15 morning glory (protective shelf)
16 flameproof sheet
17 plastic cardboard
18 safety net

1: A base material adjusting method in a repainting operation, comprising:
a coating film removing step of removing an already-existing coating film of a work object of the repainting operation by a wet blast method; and
a rust removing step of removing return rust generated after the coating film removing step by a dry blast method; and
an adjusting step which selects for removal a waste generated from the coating film removing step or another waste generated from the coating film removing step and the rust removing step.

2: A base material adjusting method in a repainting operation, comprising:
a coating film removing step of removing an already-existing coating film of a work object of the repainting operation by a wet blast method;
a rust removing step of removing rust generated after the coating film removing step by a dry blast method;
a first recovering step of recovering a first waste generated in the coating film removing step; and
a second recovering step of recovering a second waste generated in the rust removing step; wherein
an amount of abrasive material used in the wet blast method is adjusted such that the first waste becomes a general waste based on harmful material, the harmful material being the already-existing coating film of the work object in the coating film removing step.

3: A base material adjusting method in a repainting operation, comprising:
a coating film removing step of removing an already-existing coating film of a work object of the repainting operation by a wet blast method;
a rust removing step of removing rust generated after the coating film removing step by a dry blast method; and
a third recovering step of recovering a third waste which is composed of a first waste generated in the coating film removing step and a second waste generated in the rust removing step; wherein
amounts of abrasive materials used in the wet blast method and the dry blast method are adjusted such that the third waste becomes general waste based on harmful material included in the already-existing coating film of the work object in the coating film removing step and the rust removing step.

4: A base material adjusting method in a repainting operation, comprising:
a coating film removing step of removing an already-existing coating film of a work object of the repainting operation by a wet blast method;
a rust removing step of removing rust generated after the coating film removing step by a dry blast method; and
a waste recovering step of recovering a first waste generated in the coating film removing step and a second waste generated in the rust removing step; wherein
based on harmful material included in the already-existing coating film of the work object, it is selected and executed whether an amount of abrasive material used in the wet blast method is adjusted such that the first waste becomes a general waste in the coating film removing step, and the first waste and the second waste are separately recovered in the waste recovering step, or
amounts of abrasive materials used in the wet blast method and the dry blast method are adjusted such that a third waste which is composed of the first waste and the second waste becomes the general waste in the coating film removing step and the rust removing step, and the third waste is recovered in the waste recovering step.

5: The base material adjusting method according to claim 1, wherein
rust inhibitor is not included in slurry used in the wet blast method in the coating film removing step.
